(19) United States
(12) Patent Application Publication
(10) Pub. No.: US 2009/0300069 A1
(43) Pub. Date: Dec. 3, 2009

(54) Method and system for the logical deletion of relational database records

(76) Inventor: Michael Patrick O'Sullivan, Blacksburg, VA (US)

Correspondence Address: Michael P. O'Sullivan, 11700-H Cardinal Ct, Blacksburg, VA, 24060, US

(21) Appl. No.: 12/467,274

(22) Filed: May 16, 2009

Related U.S. Application Data
(60) Provisional application No. 61/130,153, filed on May 29, 2008.

(51) Int. Cl. G06F 12/00; G06F 17/30

(52) U.S. Cl. 707/200; 707/100; 707/E17.01; 707/E17.045; 711/E12.001

(57) ABSTRACT

A method and system for relational database design that allows records to be flagged as deleted but still retained in the database. Deleted records are not included in table viewing or editing activities. Reversing a deletion flag undeletes the record. Records that reference deleted records in delete-cascade relationships are flagged as deleted. Such dependent records are undeleted if the independent records are undeleted, unless the dependent records were independently flagged as deleted. If an active record is dependent on a record in a delete restrict relationship then the independent record cannot be deleted. If a foreign key references a deleted record in a delete-set-null or delete-set-default relationship then the field evaluates to null or the default value, but if the independent record is undeleted then the field returns to referencing the independent record. Unique indexes are enforced without regard to deleted records.

This application claims the benefit of U.S. Provisional Application No. 61/130,153 filed on 2008 May 29.

### STATEMENT REGARDING FEDERALLY SPONSORED RESEARCH OR DEVELOPMENT

Not applicable.

### COMPUTER PROGRAM LISTING

Two computer program listing appendixes have been uploaded with this application. Appendix 1, named “postgresql.txt”, provides the code to create an example database that embodies the patent using the DBMS PostgreSQL. Appendix 2, named “sqlite.txt”, provides an example of an aspect of the invention as implemented in the DBMS SQLite.

### REFERENCES CITED

Dave Ensor, Ian Stevenson, “Oracle Design: The Definitive Guide”, 181, O'Reilly Media, 1997
Tom Moreau, “SQL Server 2000's INSTEAD OF Triggers”, http://msdn.microsoft.com/en-us/library/aa224818(SQL.80).aspx, retrieved May 2009
Paul Nielsen, “SQL server 2005 Bible”, 532-547, John Wiley and Sons, 2006
PostgreSQL Global Development Group, “PostgreSQL: Documentation: Manuals: PostgreSQL 8.3: Unique Indexes”, http://www.postgresql.org/docs/8.3/static/indexes-unique.html, retrieved May 2009
Tom Bauch, Mark Wilding, “DB2 for Solaris: The Official Guide”, 155, Prentice Hall PTR, 2003

### BACKGROUND OF THE INVENTION

1. Field of the Invention

The present invention relates to the design of relational databases, and more particularly to the art of logically deleting and undeleting database records.

2. Background

The concept of “undeleting” is a well established concept in computing. Many software applications allow users to reverse deletions. For example, in file managers and email systems, objects that are deleted are put into a “trash can” from which they can be retrieved if desired.

In the field of relational database technology the concept of reversible deletion is called “logical deletion”, also known as “soft deletion” or “application deletion” [Oracle Design]. The idea is that a record isn't really physically removed from a database (called “physical” or “hard” deletion) but is simply flagged or stored in such a manner that it is just considered deleted. If desired, the record's deletion flag can be reversed and the record is returned to non-deleted (“active”) status. The concept of logical deletion and recovery should be distinguished from attempts at recovering data where no previous provisions were made for such recovery. This section reviews existing techniques for logical deletion and looks at their deficiencies.

One common technique for logical deletion is to have a single field that indicates if the record is active or deleted [SQL Server 2000's INSTEAD OF Triggers]. This technique typically uses a boolean field with a name like “isDeleted” that, if true indicates the record is deleted, and if false that the record is active. Some variations reverse that logic: the field has a name like “isActive” and true indicates that the record is active and false that it is deleted. Finally, some techniques use other data types to embed extra information in the field. For example, one technique uses a date field with a name like “dateDeleted”. If the field is null then the record is active. If the field is defined (that is, not null) then the record is considered deleted. All of these variations use the same basic strategy: a single field has two states, one for active, the other for deleted.

The first problem with single-field logical deletion is that it does a poor job of handling parent-child relationships [SQL server 2005 Bible]. A record that is marked as deleted in the parent table does not provide information about the active/deleted state of the child record. Even if a trigger system automatically marks child records as deleted when a parent record is deleted, that does not provide information about which child records should be undeleted if the parent record is undeleted.

Consider, for example, a database with information about employees of a company. A table called “employees” lists basic information about employees such as their names. A related table called “phones” lists phone numbers for the employees. An employee's record can have zero or more associated phone numbers. The employees and phones tables are related in a delete-cascade relationship, meaning that if an employee record is deleted then all related phone records should also be deleted.

Now suppose that the record for “Joe” has two associated phone records, one for home and one for work. The record for Joe's home phone number is flagged as deleted because Joe moved. Later, Joe's record in the “employees” table is accidentally deleted. The employee record can be undeleted by reversing the deletion flag, but it is unclear which phone records should be undeleted because they are both simply flagged as deleted without any information about why they were deleted.

Another problem with flag-based logical deletion is the handling of delete-set-null and delete-set-default relationships. In these relationships the child record is not deleted when the parent record is deleted. Rather, the field that references the parent record (the “foreign key”) is set to null or to a default value when the parent record is deleted. In this situation the deletion of the parent should result in changing the value of referencing foreign keys. Undeleting the parent should result in changing those foreign keys back to their original values. The single-field technique doesn't address storing the original reference value before the deletion and therefore provides no way of knowing the value that should be restored on the parent's undeletion.

The maintenance of unique indexes is another problem with flag-based logical deletion. If a field is supposed to have a value that is unique among all active records, then deleted records shouldn't be considered when checking for uniqueness. For example, consider a table where the name field must be unique among active records. If the unique index is constructed on the name field then it would not permit a record with a given name if a deleted record has the same name. A unique index could be constructed combining the deletion flag and the name field, but even then there could only be one deleted record with a given name in addition to a single active record with the name.

Another technique for logical deletion is to maintain a separate parallel table that is used just for deleted records. When a record is deleted it is first copied into the archive table. Then the record is physically deleted from the active table. Unfortunately this technique has many of the same fundamental problems as flagging records for deletion. It does not address cascade undeletes in terms of which child records should be undeleted when a parent record is undeleted.

It also adds a thorny problem of handling many-to-many relationships in which a single table has multiple foreign keys in delete-cascade relationships. Consider, for example, a database that has an employees table, a committees table, and a memberships table that lists which employees serve on which committees. Suppose the employee record for “Joe” is deleted, so it is first copied to a parallel archive table, then deleted from the base table. Matching membership records are cascade deleted, that is, also copied to their own archive table. Suppose further that a committee record is deleted, one which Joe had been associated with. Now suppose that Joe's record is undeleted. It is unclear what should happen the membership record. It can't be undeleted because it references a deleted committee. If it is not undeleted, but thereafter the committee record is undeleted, it is unclear how the system would know to undelete the membership record.

A distinctly different approach to logical deletion and recovery is to revert the entire database to a state before the records were deleted. Reversion can be done using several different techniques, but they all have the same objective, to produce a snapshot of the database as it was at some point in time previous to the deletion. The result is that the deleted data is recovered but any changes that were made to the database after the deletion are lost. That may be acceptable in some situations but doesn't address situations where just the deleted data is needed without a complete database reversion.

It is not always necessary to revert the entire database to recover just the deleted records. Several techniques exist to pull out just the deleted records. One simple technique is to copy the records from a backup copy of the database. Alternately, if the database system keeps transaction logs, then the logs can be searched to find just the transactions that involve the deleted records. Indeed, several products exist for that exact purpose. Unfortunately, reversion and transaction recovery techniques require inconvenient, manual searching and copying of data. They also require a set of skills completely different than those usually required to edit a database. If the deleted records are in more than one table, such as in the case of a cascade delete, the user must also understand the structure of the database in order to know where to find the deleted records. To further complicate matters, in some database designs it may be necessary to temporarily disable constraints and triggers that would otherwise prevent the data from being copied back in, an inconvenient and error prone process.

In summary, although many techniques exist to allow the recovery of logically deleted data under certain specific circumstances, there is a need for a technique that provides intuitive, flexible storage of logical deletion information over a wide range of deletion situations. The present invention provides such a solution that is intuitive in design and in use.

### SUMMARY OF THE INVENTION

An embodiment of the invention provides a method and system for the logical deletion and undeletion of relational database records. The invention makes logical deletion and undeletion more effective and intuitive than present systems by recognizing and addressing the complexities of interrelated records and by providing a familiar interface with which to affect the deletions and undeletions.

The invention achieves several specific objectives.

First, active records (that is, records that are not deleted) can be accessed through a view that appears to software to be a regular table. When records are deleted or undeleted they are automatically added to or taken from the view as appropriate.

Second, deletion is performed in the usual manner of deleting records. That is, a command is issued to the database to delete specified records from the view in the same manner a command would delete records from a table. Undeletion is also performed in a manner similar to other database manipulation techniques. A record can be undeleted by simply issuing a command to update a field in the record. Specialized tools and skills are not needed to implement the recovery of deleted data.

Third, records that are deleted as part of a cascade delete are undeleted when the parent record is undeleted. However, child records that were deleted as part of a different transaction, such as if they were directly deleted themselves, are not undeleted just because the parent was undeleted.

Fourth, deleted data is as easily accessed as active data. Active and deleted data is available in a single table and can be selected and searched in the same manner as active data.

Fifth, in a delete-set-null relationship, the deletion of the parent record results in a null value in the foreign key of the child record. If the parent record is undeleted, and the foreign key has not been changed to another value since the deletion, the foreign key returns to the value that references the parent. A delete-set-default relationship operates in a similar way. Deletion of the parent results in setting the child's foreign key to a default value, and undeletion results in a return to the value that references the parent.

Sixth, deleted data does not interfere with unique constraints on active data. If a field or combination of fields is supposed to be unique within the scope of the set of active records, then an active record may be identical in that field or fields as one or more deleted records without violation of the constraint.

The invention achieves these objectives through the use of a series of boolean fields in the tables, event triggers on the tables, views that simulate tables of just the active records, and specially designed unique indexes.

Boolean fields in each record are used to indicate the active/deleted status of the record. These fields are called “active indicators”. Each record has one independent active indicator (IAI), one effective active indicator (EAI), and zero or more foreign active indicators (FAI).

The independent active indicator (IAI) indicates if the record is considered active or deleted without regard to the status of any other record. The IAI may be true or false, not null. When a command is sent through the database interface to delete a record, that record's IAI is set to false. The IAI is not affected by cascade deletes, only by commands that directly delete or undelete the record.

Each record has one foreign active indicator (FAI) for each foreign key field that is part of a delete-cascade, delete-set-null, or delete-set-default relationship. If the foreign key references an active record then the FAI is true, else it is false. The FAI may not be null.

The effective active indicator (EAI) provides the final authoritative indication of a record's active/deleted status. If the EAI is true then the record is active, if it is null then the record is deleted. The EAI never has a defined value of false. The value of the EAI is calculated based on the values of the IAI and FAI's. If the IAI is false then the EAI is null. If any FAI that is associated with a delete-cascade foreign key is false, then the EAI is null. Otherwise the EAI is true.

The value of a record's EAI is set in a before-update trigger in the table, when it is calculated based on the described algorithm. After the record is updated, and if the record is referenced by other records, the appropriate FAI's for those referencing records are set according to the active/deleted status of the referenced record. Before the referencing records are updated their EAI's are calculated in their own before-update triggers. If those records are in turn referenced themselves then the process recurses again in their after-update triggers.

Fields or field combinations that are required to be unique should be constrained only by active records, not deleted records. To accomplish this the invention uses the fact that in evaluating expressions for uniqueness, an expression with a null value is not considered as part of the set of records in which the expression should be unique [PostgreSQL Indexes].

Finally, the technique creates views that software can use as if they were real tables of just the active records. Software can select from the views, insert records, update records, and delete records.

The actual table that contains both active and deleted records can be accessed with standard select/insert/update/delete commands.

### BRIEF DESCRIPTION OF DRAWINGS

FIG. 1 is an entity relationship diagram showing the structure of the example database created with the code in Appendix 1, “postgresql.txt”.

### DETAILED DESCRIPTION OF THE INVENTION

### 1. Glossary of Terms

Below is a list of terms used in this document. Terms noted as “for the purposes of this document” are not industry standard terms but rather are used as defined just in this document.

| TERM | DEFINITION |
|---|---|
| active | The opposite of deleted. A record that is active is not |
| | deleted. |
| DBMS | Database management system. Examples of DBMS's |
| | include PostgreSQL, MySQL, SQLite, Oracle and |
| | Microsoft Access. |
| defined | For the purposes of this document, the opposite of null. A |
| | value that is defined is not null. |
| delete- | A hierarchical relationship between database records in |
| cascade | which the child record is automatically deleted if the parent |
| | record is deleted. |
| delete- | A hierarchical relationship between database records in |
| restrict | which the parent record cannot be deleted if there are any |
| | active child records. |
| delete- | A hierarchical relationship between database records in |
| set-default | which the child record's foreign key is set to a default value |
| | if the parent record is deleted. |
| delete- | A hierarchical relationship between database records in |
| set-null | which the child record's foreign key is set to null if the |
| | parent record is deleted. |
| deletion | For the purposes of this document “deletion” means logical |
| | deletion, not physical deletion. |
| effective | For the purposes of this document, a boolean field that gives |
| active | the authoritative indication of the active/deleted status of a |
| indicator | record. If the EAI is true then the record is active. If it is |
| (EAI) | null then the record is deleted. The EAI never has a defined |
| | value of false. |
| event | A set of commands that are executed when specific events |
| trigger | occur in the database such as when records are inserted, |
| | updated, or deleted. Trigger commands may modify the |
| | values of records affected by the event or may cancel the |
| | entire transaction if errors are found. |
| foreign | For the purposes of this document, a boolean field that |
| active | indicates the active/deleted status of the record that is |
| indicator | referenced in a matching foreign key. Every foreign key |
| (FAI) | that is part of a delete-cascade, delete-set-null, or delete-set- |
| | default relationship has a matching FAI. |
| foreign | A field or combination of fields that contains the primary |
| key | key of another record. For the purposes of this document a |
| | foreign key is always a single field. |
| inde- | For the purposes of this document, a boolean field that |
| pendent | indicates a record's active/deleted status without regard to |
| active | the status of any other records. A record's IAI is not |
| indicator | changed by the deletion or undeletion of other records. If |
| (IAI) | the IAI is false then the record is considered deleted. |
| | However, a value of true is not necessarily sufficient to |
| | indicate that a record is active. |
| inde- | For the purposes of this document, the act of directly |
| pendent | deleting a record by using the database interface. An |
| deletion | independent deletion is distinguished from a cascade delete |
| | in which a record is deleted as the result of another record's |
| | deletion. |
| logical | To flag a record as deleted without actually removing the |
| deletion | record from the database. |
| null | A special value that indicates unknown or missing data. |
| | Null has its own set of special rules for comparing it to |
| | other data. Although some database management systems |
| | use their own rules, official SQL specifications indicate that |
| | a null value is not considered equal to any other value, not |
| | even another null. |
| physical | To permanently delete a record from the database. Although |
| deletion | many database systems do not actually immediately |
| | physically destroy deleted data on the storage device, no |
| | provisions are made for the data's recovery and physical |
| | deletion should be assumed permanent. |
| transaction | A set of changes to a database that are either entirely saved |
| | to the database or none of which are not saved at all. At any |
| | point during the process of building the changes the entire |
| | transaction can be canceled and the database rolled back to |
| | the state as it was before the transaction began. |
| undelete | For the purposes of this document, to change the flag of a |
| | logically deleted record from deleted to active. |
| unique | A mechanism that enforces a rule that a field or combination |
| index | of fields must be unique within the scope of a table. |
| view | An object that appears to software to be a database table. At |
| | a minimum a view must allow software to select from the |
| | view. Methods may be added to the view that allow |
| | software to insert, update, or delete from the view. |
| view rule | A method that is added to a view that allows software to |
| | perform insert, update, or delete actions on the view, even |
| | though the view is not actually a table of data. The actions |
| | performed may include, but are not limited to, inserting, |
| | updating, or deleting data in real tables, checking if data |
| | implements various business rules, or even nothing at all. |
| | Data that is sent to the method is available for use by the |
| | code that implements the view rule. |

### 2. Method and Technique

The invention utilizes four types of database objects: tables, event triggers, views, and unique indexes.

For each table, active and deleted records are all stored in a “base table”. Base tables include a series of fields that, taken together, indicate if a record is active or deleted. These fields are called “active indicators”. Active indicators are set when a record is deleted or undeleted. These fields distinguish between records that were deleted directly and records that were cascade deleted because they are dependent on another record that was deleted.

There are three types of active indicators.

Each record has exactly one independent active indicator (IAI) field that indicates if the record is considered active without regard to any other record's active/deleted status. IAI's are boolean and may not be null.

In tables that have one or more foreign keys, foreign keys that are part of delete-cascade, delete-set-null, or delete-set-default relationships have associated foreign active indicator (FAI) fields. FAI's are boolean and may not be null. If the referenced record is flagged as active then the corresponding FAI is true. If the referenced record is flagged as deleted then the corresponding FAI is false.

Each record has exactly one effective active indicator (EAI) field that indicates the final determination of the record's active/deleted status. EAI's are boolean. Unlike other active indicators, EAI's may be true or null, but not false. True indicates that the record is active, null indicates that the record is deleted. The EAI is calculated based on the other active indicators. If and only if the IAI and the FAI's that are associated with delete-cascade relationships are all true then the EAI is set to true. Otherwise the EAI is set to null.

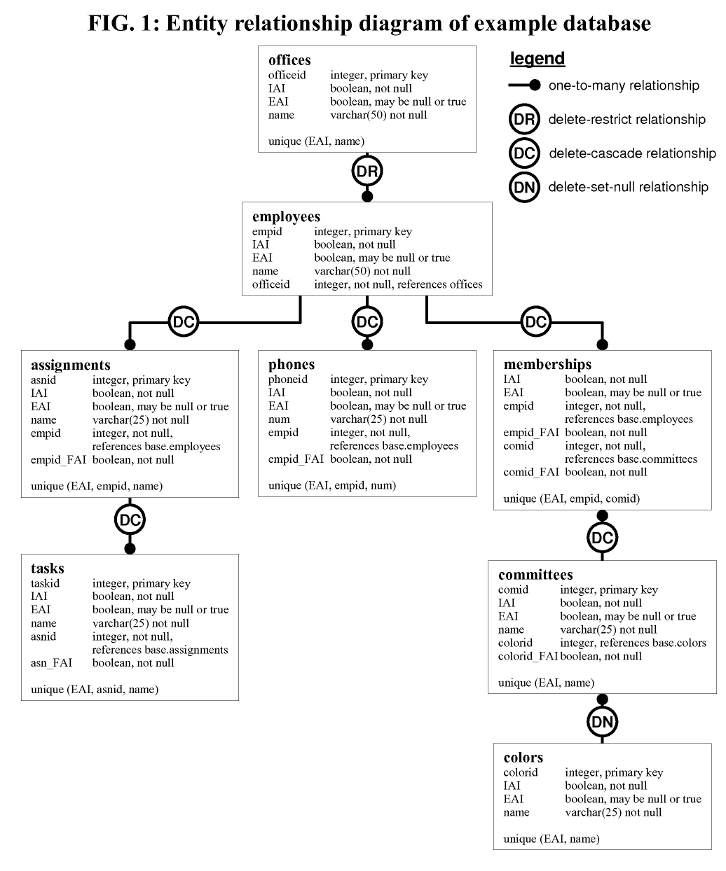

In the example in Appendix 1, a simple table that has no foreign keys would just have an IAI and an EAI. The following code creates the offices table which has no foreign keys. See FIG. 1 for an entity relationship diagram (ERD) of the table design.

| 19 create table offices ( | |
|---|---|
| 20 officeid | int primary key, |
| 21 | |
| 22 -- independent active indicator | |
| 23 IAI | boolean not null default true, |
| 24 | |
| 25 -- effective active indicator | |
| 26 EAI | boolean default true check(EAI), |
| 27 | |
| 28 -- name of office | |
| 29 name | varchar(50) not null, |

30
31 -- enforce correct results for EAI
32 constraint check_EAI
33 check (
34 case when IAI then
35 EAI is not null
36 else EAI
37 is null
38 end
39 )
40 );

### Code Example 1, from Appendix 1

### Code to Create a Table with No Foreign Keys

Line 23 creates the IAI field which is a boolean field and may not be null. Line 26 creates the EAI field which is boolean and may be true or null, but not false. Lines 32-39 define a constraint that enforces the rule about how EAI should be calculated. Note that the constraint does not actually change the value of EAI, it merely checks the value. The process that sets the value will be described in the triggers section. Also note that IAI and EAI default to true. In this embodiment it is assumed that new records are always active.

In a more complex case, where the table has a foreign key in a delete-cascade relationship, the definition may include an FAI associated with the foreign key. In the following example from Appendix 1, the phones table has a delete-cascade foreign key to the employees table. It also has an FAI associated with the foreign key.

| 754 create table phones ( | |
|---|---|
| 755 phoneid | int primary key, |
| 756 | |
| 757 -- independent active indicator | |
| 758 IAI | boolean not null default true, |
| 759 | |
| 760 -- effective active indicator | |
| 761 EAI | boolean default true check(EAI), |
| 762 | |
| 763 -- phone number and phone number type | |
| 764 num | varchar(50) not null, |
| 765 | |
| 766 -- foreign key to employees | |
| 767 empid | int not null references base.employees |
| 768 | on delete cascade, |
| 769 empid_FAI | boolean not null default true, |

770
771 -- enforce correct results for EAI
772 constraint check_EAI
773 check (
774 case when IAI and empid_FAI then
775 EAI is not null
776 else
777 EAI is null
778 end
779 )
780 );

### Code Example 2, from Appendix 1

### Code to Create a Table with a Foreign Key in a Delete-Cascade Relationship

Lines 758 and 761 define the IAI and EAI fields as in the previous example. Lines 767-768 define a foreign key to the employees table in a delete-cascade relationship. Line 769 creates an FAI associated with the empid field called empid_FAI. empid_FAI is a boolean field and may not be null. Lines 772-779 define a constraint to enforce the rule that if IAI and empid_FAI are both true then EAI is defined (and, implicitly, true), otherwise it is null.

It is important to reiterate that only FAI's associated with delete-cascade relationships are considered in calculating the EAI. FAI's associated with delete-set-null and delete-set-default relationships do not affect the final determination of the record's active/deleted state. For example, consider a situation in which each committee in an organization is assigned a color code for documents, email, etc. If a color record is deleted the committee record shouldn't be deleted; the value of the color code should simply revert to null. Such a structure would use an FAI for the foreign key to the colors table, but the constraint to check the EAI would not include the FAI. Such a structure could be coded as follows.

| 412 create table committees ( | |
|---|---|
| 413 comid | int primary key, |
| 414 | |
| 415 -- independent active indicator | |
| 416 IAI | boolean not null default true, |
| 417 | |
| 418 -- effective active indicator | |
| 419 EAI | boolean default true check(EAI), |
| 420 | |
| 421 -- committee name | |
| 422 name | varchar(50) not null, |
| 423 | |
| 424 -- foreign key to colors | |
| 425 colorid | int references colors on delete set null, |
| 426 colorid_FAI | boolean not null default true, |

427
428 -- enforce correct results for EAI
429 constraint check_EAI
430 check (
431 case when IAI then
432 EAI is not null
433 else
434 EAI is null
435 end
436 )
437 );

### Code Example 3, from Appendix 1

### Code to Create a Table with a Foreign Key in a Delete-Set-Null Relationship

The IAI and EAI fields are defined as in previous examples. The colorid_FAI field is defined in line 426 in the same way that the FAI is defined in the previous example. The constraint defined in lines 429-436, however, only checks EAI based on IAI, not on colorid_FAI.

Foreign keys associated with delete-restrict relationships do not require FAI's because there should never be a situation where an active record references a deleted record.

Database event triggers are used to set active indicators and to check data integrity constraints. Triggers used in this invention are fired before record inserts, before record updates and after record updates.

Before-insert triggers are used to check that foreign keys reference only active records. For example, if the table phones has a foreign key empid that references the employees table then a new record should only reference active records in employees. Code in the before-insert trigger such as follows from Appendix 1 would enforce the rule.

787 create function phones_bi( ) returns trigger as $$
788 declare
789 v_employees int;
790 begin
791 -- new record must be associated with active employee
792 if new.empid is not null then

| | |
|---|---|
| 793 select | count(*) |
| 794 into | v_employees |
| 795 from | active.employees |
| 796 where | empid = new.empid; |

797
798 if v_employees = 0 then
799 raise exception
800 ‘do not have employee with empid=%’, new.empid;
801 end if;
802 end if;
803
804 return new;
805 end;
806 $$ language plpgsql;

### Code Example 4, from Appendix 1

### Code to Create a Before-Insert Trigger to Check the Integrity of Foreign Keys

Lines 793-796 select the count of active employee records that have the new empid. Line 798 checks if that count is zero (meaning that the referenced record does not exist in the active set) and, if so, lines 799-800 throw an exception and the entire transaction is canceled.

Before-update triggers perform two functions. First, if the value of a foreign key field changes then the before-update trigger should check that the new value references an active record. Second, the before-update trigger recalculates the EAI based on the value of the IAI and applicable FAI's.

The following code from Appendix 1 creates a before-update trigger for the phones table that provides an example of these actions.

813 create function phones_bu( ) returns trigger as $$
814 declare
815 v_employees int;
816 begin
817 -- empid may only change to active employee record
818 if (new.empid is not null) and
819 (new.empid <> old.empid) then

| | |
|---|---|
| 820 select | count(*) |
| 821 into | v_employees |
| 822 from | active.employees |
| 823 where | empid = new.empid; |

824
825 if v_employees = 0 then
826 raise exception
827 ‘do not have employee with empid=%’, new.empid;
828 end if;
829
830 new.empid_FAI := true;
831 end if;
832
833 -- set EAI
834 if new.IAI and new.empid_FAI then
835 new.EAI := true;
836 else
837 new.EAI := null;
838 end if;
839
840 return new;
841 end;
842 $$ language plpgsql;

### Code Example 5, from Appendix 1

### Code to Create a Before-Update Trigger

Lines 818-819 check two things: if the new value of empid is defined (that is, not null) and if the value has changed. If these tests evaluate to true, lines 820-828 check if the new empid is in the active set of employee records as in the previous example.

Lines 834-838 reset the value of EAI. If the new values of IAI and empid_FAI are both true then the new EAI is set to true. Otherwise the new EAI is set to null.

A table can have multiple delete-cascade foreign keys with multiple associated FAI's. For example, consider the following structure: an employees table, a committees table, and a memberships table that matches employees to committees in a many-to-many relationship. The before-update trigger for memberships would set the EAI based on the IAI and also two different FAI's, as in the following code.

697 if new.IAI and new.empid_FAI and new.comid_FAI then
698 new.EAI := true;
699 else
700 new.EAI := null;
701 end if;

### Code Example 6, from Appendix 1

### Code to Set the EAI Based on the IAI and two FAI's

Because the active/deleted status of a membership record depends on the status of two different foreign records, both of those records (as well as the IAI) must be active for the membership record to be active. If either foreign record is deleted then the membership record is deleted. If either foreign record is undeleted, the matching FAI is set to true and the EAI is recalculated.

Some database management systems do not provide the ability to set a field's value in a before-update trigger, but do provide the ability to do so in a non-recursive after-update trigger. SQLite is an example of such a DBMS. In a situation like that it is possible to use an after-update trigger to set the EAI. The following code from Appendix 2 demonstrates code to create such an after-update trigger. After a record is updated, the after-update trigger updates the record again to update the EAI. Because the trigger is non-recursive the before and after update triggers are not called again because of this new update.

23 create trigger cities_EAI
24 after update of IAI on cities
25 begin
26 update cities
27 set EAI =
28 case
29 when new.IAI then 1
30 else null
31 end
32
33 where cityid = new.cityid;
34 end;

### Code Example 7, from Appendix 2

### Code to Create an After-Update Trigger in SQLite

An after-update trigger is also used to update the FAI's in foreign records that reference the record that has been updated. If the updated record's active status has changed then the FAI's for referencing records should change too. A true EAI changes the foreign FAI's to true; null changes them to false.

The following code demonstrates the technique. In this example the committees table is referenced by the memberships table. Therefore the committees table's after-update trigger sets the values of comid_FAI in the memberships table as in the following code.

| 511 create function committees_au( ) returns trigger as $$ | |
|---|---|
| 512 declare | |
| 513 v_FAI boolean; | |
| 514 begin | |
| 515 -- determine if active state changed | |
| 516 if (old.EAI is null) and (new.EAI is not null) then | |
| 517 v_FAI := true; | |
| 518 elsif (old.EAI is not null) and (new.EAI is null) then | |
| 519 v_FAI := false; | |
| 520 end if; | |
| 521 | |
| 522 -- If EAI has changed then update actve/deleted state | |
| 523 -- of dependent membership records | |
| 524 if v_FAI is not null then | |
| 525 update | base.memberships |
| 526 set | comid_FAI = v_FAI |
| 527 where | comid = new.comid; |

528 end if;
529
530 return new;
531 end;
532 $$ language plpgsql;

### Code Example 8, from Appendix 1

### Code to Create an After-Update Trigger

Lines 516-520 set the value of a boolean variable based on the value of the EAI. If the resulting boolean is defined (meaning that the EAI has changed) then lines 525-527 set the values of referring records based on the value of the boolean variable.

Updating foreign record FAI's triggers the before-update and after-update routines for those records, thereby setting their EAI's and further setting the FAI's of records that in turn reference them. In multiple level parent-child-grandchild relationships deletions and undeletions will be recursed through multiple tables.

Unique constraints must be designed in such a way that deleted records are not considered when determining if active records conform to the constraint. A field or combination of fields that must be unique in the active set should not be required to be unique in the deleted set. Even multiple instances of the unique constraint combination must be allowed in the deleted set.

The invention utilizes the fact that in standard database implementations a null value is not considered equal to any other value, not even another null. That means that an expression that includes null is not considered equal to any other expression, even where the other fields in the expression are equal. Therefore, a unique index that incorporates the EAI into the index expression will never violate unique constraints with deleted records, because for deleted records the EAI is null.

For example, consider the offices table which has a name field. Every name in the active set should be unique. Line 43 in Appendix 1 demonstrates how such an index would be created.

43 create unique index offices_name_idx on offices(EAI, name);

### Code Example 9, from Appendix 1

### Code to Create a Unique Index on the EAI and a Single Field

If the table should have a unique combination of fields then the expression should list those fields along with the EAI. For example, the following code creates a unique index on a combination of the fields num and empid.

783 create unique index phones_empid_num_idx
784 on phones (EAI, num, empid);

### Code Example 10, from Appendix 1

### Code to Create a Unique Index on the EAI and Multiple Other Fields

Not all DBMS's implement null in unique indexes as described above. For example, DB2 considers a null value as equal to another null value [DB2 for Solaris]. Those DBMS's cannot be used to implement this aspect of the invention.

In order for software to interact with what appears to be a table of just the active records the preferred embodiment of the invention uses a view. The view provides interfaces for four functions: select, insert, update, and delete.

The view is created using a select statement that selects only records with a true EAI and selects all fields except active indicators. For example, the following code creates a view of the active records in the phones table.

| 849 create view active.phones as | |
|---|---|
| 850 select | phoneid, empid, num |
| 851 from | base.phones |
| 852 where | EAI; |

### Code Example 11, from Appendix 1

### Code to Create View that Selects Just Active Records

In the situation of a delete-set-null or delete-set-default relationship the select statement is more complex. The statement must address the need for setting the foreign key's value to null or a default value if the referenced record is deleted, then setting it back on undeletion. This objective is achieved by an expression in the view's select statement that evaluates to the field's value if the FAI is true, and null or a default value if the FAI is false. For example, the following statement creates a view in which the field colorid evaluates to the base table's colorid field if colorid_FAI is true, and null if it is not.

| 539 create view active.committees as | |
|---|---|
| 540 select | comid, |
| 541 | name, |
| 542 | case when colorid_FAI then colorid |
| 543 | else null end as colorid |
| 544 from | base.committees |
| 545 where | EAI; |

### Code Example 12, from Appendix 1

### Code to Create a View in which One of the Fields is Part of a Delete-Set-Null Relationship

The insert rule accepts the inputs and passes them straight through to the base table. For example the following code creates an insert rule for the committees view.

548 create rule “committees_insert” as
549 on insert to active.committees
550 do instead
551 insert into
552 base.committees (
553 comid,
554 name,
555 colorid
556 )
557
558 values (
559 new.comid,
560 new.name,
561 new.colorid
562 );

### Code Example 13, from Appendix 1

### Code to Create an Insert Rule for a View

In a similar manner, the update rule also passes through all values, as in this example for the committees view.

| 565 create rule “committees_update” as | |
|---|---|
| 566 on update to active.committees | |
| 567 do instead | |
| 568 update | base.committees |
| 569 set | name = new.name, colorid = new.colorid |
| 570 where | comid = old.comid; |

### Code Example 14, from Appendix 1

### Code to Create an Update Rule for a View

The delete rule sets the IAI to false instead of actually physically deleting any records. The following code performs this task for the committees view.

| 573 create rule “committees_delete” as | |
|---|---|
| 574 on delete to active.committees | |
| 575 do instead | |
| 576 update | base.committees |
| 577 set | IAI = false |
| 578 where | comid = old.comid; |

### Code Example 15, from Appendix 1

### Code to Create a Delete Rule for a View

Although the invention has been described in terms of various embodiments, it is not intended that the invention be limited to those embodiments. Modification within the spirit of the invention will be apparent to those skilled in the art. For example, although the embodiments in the specification use the computer language SQL, other database manipulation languages could be used such as Java Persistence Query Language or even the native language in which the database is written such as C++. The scope of the invention is defined by the claims that follow.

1. A method for flagging a relational database record as deleted or active (where “active” means not deleted) comprising:
each record has an independent active indicator (IAI) that can be true or false; a false state indicates that the record is deleted regardless of the active/deleted state of any other records; a true state means that the record is not considered deleted without regard to the active/deleted state of other records, but a true state is not sufficient in all cases to indicate that the record is active;
for each record, each foreign key in a delete-cascade, delete-set-null, or delete-set-default relationship has a matching foreign active indicator (FAI); if the referenced record is flagged as deleted then the FAI is false; else it is true;
each record has an effective active indicator (EAI) that can be true or null (but not false); the EAI provides the final and authoritative indicator of the active/deleted status of the record; if the EAI is true then the record is active; if the EAI is null then the record is deleted; the EAI is calculated from the IAI and FAI's as follows:
if the IAI is false then the EAI is null;
else if any of the FAI's associated with foreign keys that reference foreign records in delete-cascade relationships are false then the EAI is null;
else the EAI is true.

2. The method of claim 1, in which the process of maintaining referential integrity and of setting the active indicators of the record and of records that reference it is as follows:
before a record is inserted, a database trigger checks that defined foreign keys in the record reference records where the EAI is true and if not, the transaction is canceled;
before a record is updated, a database trigger sets the record's EAI based on the rules described in claim 1;
before a record is updated, a database trigger checks if the record's EAI is being changed from true to null, and if the record is referenced by active foreign records in a delete-restrict relationship, and if so then the record is not updated and the transaction is canceled;
in systems that do not provide the capability to update a field in a before-insert trigger, but which provide for non-recursive after-update triggers, an after-update trigger may be used to recalculate the EAI based on the rules described in claim 1;
after the record is updated, a database trigger sets the FAI's of all records that reference the updated record in delete-cascade, delete-set-null, and delete-set-default relationships setting them to true if the EAI is true and false otherwise;
database triggers are run before and after the saving of referencing records in the same manner, resulting in a recursive process.

3. The method of claim 1, further comprising: when a field or combination of fields must be unique within the scope of the set of active records in a table, an index is created which requires a unique combination of the field or fields and the EAI; such an index will ignore instances in which the EAI is null, therefore only records flagged as active will be considered when determining if the field or combination of fields is unique.

4. The method of claim 1, further comprising an interface through which software can interact with only the active records in a table:
the interface consists of a database view object that selects only records where the EAI is true;
the view object provides an insert method such that records can be inserted into the table by using database code that appears to insert the records into the view;
the view object provides an update method such that active records and only active records can be updated using database code that appears to update the records in the view;
the view object provides a delete method such that records can be flagged as deleted using database code that appears to delete records from the view; instead of physically deleting records the method sets their IAI's to false, which results in setting their EAI's to null;
for foreign key fields in which, if the foreign record is deleted then the field is set to null (known as a “delete-set-null” relationship), the view object returns null if the foreign key's FAI is false, and returns the foreign key's value if the FAI is true;
for foreign key fields in which, if the foreign record is deleted then the field is set to a default value (known as a “delete-set-default” relationship), the view object returns the default value if the foreign key's FAI is false, and returns the foreign key's value if the FAI is true.
